(19) United States
(12) Patent Application Publication
(10) Pub. No.: US 2024/0322565 A1
(43) Pub. Date: Sep. 26, 2024

(54) Method for managing the electric power supply to devices

(71) Applicant: ORANGE, Issy-les-Moulineaux (FR)

(72) Inventors: Julien Cumin, CHATILLON CEDEX (FR); Julien Pairis, CHATILLON CEDEX (FR)

(21) Appl. No.: 18/692,110

(22) PCT Filed: Sep. 14, 2022
(86) PCT No.: PCT/FR2022/051733

§ 371 Date: Mar. 14, 2024

(30) Foreign Application Priority Data
Sep. 16, 2021 (FR) FR2109717

(51) Int. Cl. H02J 3/00; G05B 15/02

(52) U.S. Cl. CPC H02J 3/00; G05B 15/02

(57) ABSTRACT

A method for managing the electrical supply of electrical appliances connected to one another via a communication connection and capable of assuming a plurality of electrical power states. The method includes: a) a phase for grouping electrical appliances according to the criterion that only one of the appliances can be used at any given time; b) a phase for detecting a change in the electrical state of one of the appliances in the group obtained after the grouping phase, the new state being representative of a desire to use the appliance; and, c) a phase for managing the electrical supply states of other appliances in the group according to the criterion that only one of the appliances in the group can be used at any given time.

### TECHNICAL FIELD

The technical field is that of electric power supply to devices.

More specifically, the invention relates to a method for managing the electric power supply to devices.

The devices in question are, first of all, household electrical devices, and in particular devices dedicated to audio-visual broadcasting, which have the characteristic of being able to be used only separately. What is meant by this term is devices which, at some point in their use, form a group in which at most only one device can function usefully at a given moment. The most obvious example of this situation is given by a group of items of equipment which emit an audio-visual signal for broadcast by a single television set: in a home, it is common for a DVD player, a Blu-ray player, a television decoder, a game console or still other devices to be plugged into a single television set. At most only one of these devices can usefully broadcast its audio-visual signal to the television set which will display it in the home.

Besides devices for domestic use, devices which form a group which are used separately in other contexts can be found. For example, in industry, a situation may arise where the electric power supply to a workshop is limited and where, in a group of devices, only one can be used at full power at a given instant.

### PRIOR ART

Managing the electric power supply to devices is necessary to optimize and economize the power consumption of said devices. In general, electrical devices have a standby mode which makes it possible to reduce the power consumption of an unused device without completely unplugging it. Putting a device on standby makes it possible to restart it more quickly than if it were completely unplugged, while making it possible to significantly reduce power consumption. This putting on standby generally occurs at the request of a user using a remote control. This putting on standby can also be triggered automatically after a certain period of inactivity for certain devices.

However, the situation of devices which form a group which are used separately is not used to make it easier to put them on standby automatically, although this fact could be used. The HDMI protocol (acronym for High-Definition Multimedia Interface) has a functionality called CEC (for Consumer Electronics Control) which makes it possible to put an entire set of devices on standby by pressing only one remote control button. However, this functionality remains triggered only by a user pressing a remote control button.

The invention aims to improve the situation.

### THE INVENTION

According to a first functional aspect, the invention relates to a method for managing the electric power supply to electrical devices which are connected to one another via a communication link and capable of taking several electric power supply states, wherein it comprises:
a) a phase of grouping electrical devices according to the criterion that only one of these devices can be used at once at a given moment;
b) a phase of detecting a change in the electrical state of one of the devices in the group which is obtained following the grouping, the new state being representative of a desire to use said device; and
c) a phase of managing the electric power supply states of the other devices in said group according to the criterion that only one of the devices in the group can be used at once at a given moment.

In one embodiment, the management phase consists in issuing orders to change electrical state to some of the electrical devices in the group which is obtained following the grouping. These orders can be chosen from orders to put the device on standby or orders to cut off the electric power supply to the device. In all embodiments, the management phase is carried out so as to respect the criterion that only one of the electrical devices can be used at once at a given moment.

Thanks to the invention, the user of a device from the group will no longer have to switch the devices which they are not using at a given moment into standby mode. This automatic switch is performed by managing the electric power supply states of the unused devices, after the user signals that they wish to use a device. This wish is signalled, for example, by pressing a button on the device in question or of a remote control. The automatic management will ensure that the criterion that only one of the devices in the group can be used at once will be respected. This automatic management will be specified in later embodiments of the invention but will generally consist in sending orders to the other devices. This is a practical advantage of the invention, which relieves the user of having to carry out all of the orders to put the other devices on standby.

In addition, a second advantage of this switch is that it makes it possible to make energy savings. Indeed, putting unused devices on standby becomes systematic since it is not left to the discretion of the user.

Still according to a first particular implementation of the invention, one of the electrical devices is designated as the main device intended to be used by secondary devices, and the grouping phase a) applies to the secondary devices according to the criterion that only one of these secondary devices uses the main device at once at a given moment.

Thanks to this first implementation, the invention is applied to its most frequent use case in the domestic environment, namely a set of household electrical devices such as a DVD or Blu-ray player, or a television decoder, which use another device, such as a television or a high-fidelity speaker, to broadcast images or sounds, which act as the main device.

According to a second particular implementation of the invention, which can be implemented together with the preceding implementation, the phases a) to c) of grouping devices, of detecting a change in state, and of managing the electric power supply states, are carried out by the main device.

In this second embodiment, it is the main device which implements the management method, carrying out the grouping, detection, and management phases. The advantage of this architecture is that it approximates the structure often observed in the domestic environment, namely a main device used exclusively by secondary devices. This centralized architecture has the advantage of relying on the computing resources of the main device, which are a priori more substantial than those of the other devices.

According to a third particular implementation of the invention, which can be implemented as an alternative to the preceding implementation, the phases a) to c) of grouping devices, of detecting a change in state, and of managing the electric power supply states, are carried out by all or some of the devices.

Thanks to this particular implementation of the invention, the invention is implemented in a decentralized architecture. The advantage of this architecture is that it does not make assumptions about the various functionalities of the devices and uses all of the computing capabilities of the electrical devices.

According to a fourth particular implementation of the invention, which can be implemented together with the other implementations, the management phase c) comprises systematically sending orders to change electrical state to all the other devices in the group.

In this particular implementation, the management phase consists in systematically issuing orders to change electrical state to the other devices in the group. If the order to change electrical state issued to one or more devices in the group was not necessary because these devices were already in the targeted state, that is to say put on standby or not supplied with electric power, this implementation is of no consequence because the order will quite simply be ignored. The advantage of this implementation is that it simplifies the management phase of the method by making it systematic by sending orders to all the other devices in the group. This implementation therefore makes it possible to avoid having to know the information on the electrical status of the devices to perform the management phase and issue the orders to change electrical state.

According to a fifth particular implementation of the invention, which can be implemented together with the preceding implementations, the management phase c) comprises sending orders to change electrical state to a subset of said other devices in the group so as to respect the criterion that only one of the devices in the group can be used at once at a given moment, the devices in said subset being chosen according to their respective electrical states.

In this particular implementation, the management phase consists in issuing orders to change electrical state, said issuing being limited to the orders necessary to ensure that the criterion that only one of the devices in the group can be used at once at a given moment is respected. More specifically, an order to change electrical state would not be issued in this implementation to a device which is on standby or off since its state will not prevent the criterion from being respected. The advantage of this implementation is that it limits sending orders to change electrical state to what is strictly necessary.

According to a sixth particular implementation of the invention, which can be implemented together with the preceding implementations, one of the several orders to change electrical state is a standby order.

Putting an electrical device on standby makes it possible to significantly reduce its power consumption, while keeping certain functionalities activated. These activated functionalities make it possible to reboot the device more easily. The advantage of this implementation is therefore that it ensures that the invention is more practical, by starting up the electrical devices more quickly after they have been put on standby.

According to a seventh particular implementation of the invention, which can be implemented as an alternative to the preceding implementations, one of the several orders to change electrical state is an order to cut off the electric power supply.

Thanks to this implementation, it is possible to apply the invention to electrical devices which do not have a controllable standby mechanism. The cutting off of the electric power supply can then be triggered, for example, by a connected power outlet which supplies power to the device targeted by the cut-off order, or by any other means.

According to a first hardware aspect, the invention relates to a management entity capable of performing a method for managing the electric power supply to electrical devices which are connected to one another via a communication link and capable of taking several electric power supply states, wherein the entity comprises:
a) a grouping module capable of grouping electrical devices according to the criterion that only one of these devices can be used at once at a given moment;
b) a detection module capable of detecting a change in the electrical state of one of the devices in the group which is obtained following the grouping, the new state being representative of a desire to use said device; and
c) a management module capable of managing the electric power supply states of the other devices in said group according to the criterion that only one of the devices in the group can be used at once at a given moment.

According to a second hardware aspect, the invention relates to an electrical device comprising a management module capable of performing the management method defined above.

According to another hardware aspect, the invention relates to a computer program capable of being implemented by an electrical device, the program comprising code instructions which, when it is executed by a processor, performs the steps of the management method which is defined above.

Finally, according to another hardware aspect, the invention relates to a data medium on which a computer program, comprising sequences of instructions for implementing the management method defined above, is stored.

The data medium can be any entity or device capable of storing the programs. For example, the medium can comprise a storage means, such as a ROM, for example a CD-ROM or a microelectronic circuit ROM, or else a magnetic recording means, such as a hard disk. On the other hand, the medium can be a transmissible medium such as an electrical or optical signal, which can be routed via an electrical or optical cable, by radio or by other means. The program according to the invention may be, in particular, downloaded over the Internet. Alternatively, the data medium may be an integrated circuit into which the program is incorporated, the circuit being designed to execute or to be used in the execution of the method in question. The program according to the invention can use any type of computer technology in terms of compiled or interpreted programming languages or a combination of the two, as well as in terms of operating systems.

The invention will be better understood on reading the following description, which is given by way of example and with reference to the appended drawings, in which:

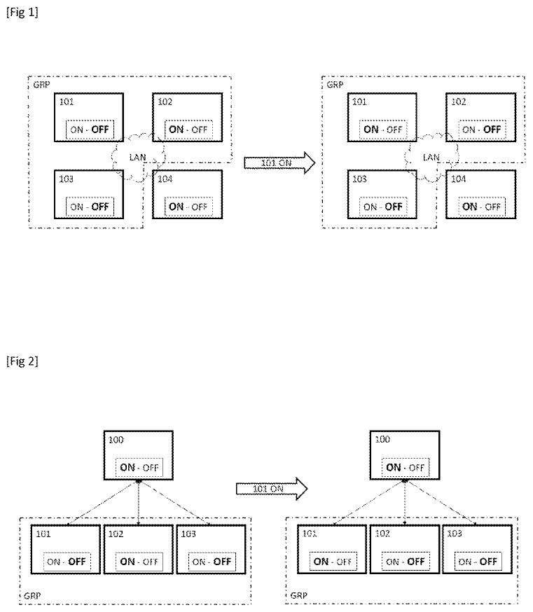

FIG. 1 depicts a group of three electrical devices and a fourth electrical device and the evolution of their electric power supply state according to the management method.

FIG. 2 depicts a main device and a group of three secondary devices and the evolution of their electric power supply state according to the management method.

FIG. 1 depicts four electrical devices 101, 102, 103 and 104.

A device has the hardware architecture of a conventional computer. It notably comprises a processor, a RAM and a read-only memory such as Flash memory, and a communication module for communicating with other devices. The electrical devices 101, 102, 103 and 104 are connected to one another by a communication link. In FIG. 1, this link is a local area network LAN to which the four devices belong, but any other type of link is possible, for example a link using radio-frequency technology such as Bluetooth, the RF4CE protocol (acronym for Radio Frequency For Consumer Electronics) or UWB (acronym for Ultra Wide Band). In a variant, the communication link can also be produced by connecting the devices 101, 102, 103 and 104 to the Internet.

The electrical state of the devices 101, 102, 103 and 104 is depicted schematically with a rectangle containing the words ON and OFF. The electrical state of the device under consideration is depicted in FIG. 1 by the emboldening of the word ON or of the word OFF. When the word ON is in bold, the concerned device is supplied with electric power. When the word OFF is in bold, the concerned device is supplied with minimum power. The device in question may then be in a standby state, or its electric power supply may even be completely cut off. In the left part of FIG. 1, the devices 102 and 104 are supplied with electric power (ON in bold) while the devices 101 and 103 are not supplied with electric power or are on standby (OFF in bold).

The method comprises three phases a) to c) which are described in detail below. A first, grouping phase a) consists in grouping some of the electrical devices 101 to 104 according to the criterion that only one of the grouped devices can be used at once at a given moment. A second, detection phase b) consists in detecting the change in the electrical state of one of the devices in the group which is obtained following the grouping, the new state being representative of a desire to use said device. A third, management phase c) will ensure that the criterion according to which only one of the devices grouped in the grouping phase a) can be used will indeed be respected even after the change of electrical state detected in phase b).

In the left part of FIG. 1, the result of the phase a) of grouping electrical devices according to the criterion that only one of these devices can be used at once at a given moment is depicted by a dotted shape isolating the devices 101, 102 and 103, which are therefore grouped in a group GRP. The device 104 is not part of the group GRP and it is, in fact, supplied with electric power (ON in bold) and can therefore be used while this is also the case for the device 102. In the group of devices 101, 102 and 103, only one device can be used at once at a given moment. For the moment described by the left part of FIG. 1, only the device 102 is supplied with electric power.

The phase a) of grouping the devices 101, 102 and 103 can be carried out in several ways. It is possible that the grouping is defined by default, when the devices are initially started, due to the nature of the devices concerned and their relationship. The grouping phase a) can also occur at the initiative of one of the devices 101, 102, 103 and 104. The grouping phase a) can also occur by means of broadcasting informative messages about their functionalities by means of the devices concerned and by means of a protocol similar to distributed election protocols. A last possibility is that there is a device (not depicted in FIG. 1), such as a smartphone or a touchscreen tablet, connected to all of the devices 101, 102, 103 and 104, for example by the local area network LAN; in this configuration, this device makes it possible for a user to proceed to the phase a) of grouping the devices 101, 102 and 103 in the group GRP according to the criterion that only one of these devices 101, 102 and 103 can be used at once at a given moment. In this variant, it is the user who controls the grouping phase a) and who can change the devices which are members of the group GRP according to their needs.

Let it be specified that the grouping phase a) can be executed several times. After the initial execution of the grouping phase a), the latter can be repeated, for example, in order to integrate new devices into the group GRP or, on the contrary, to remove some. Additional executions of the grouping phase a) can, for example, be triggered when new electrical devices are detected in the vicinity of the local area network LAN or else at the request of a user.

The phase b) of detecting a change in the electrical state of the device 101 in the group GRP is depicted in FIG. 1 by an arrow located in the middle of the figure, labelled by the inscription “101 ON”. This phase b) corresponds, for example, to the detection of an action of a user who wishes to use the device 101 and who will press a mechanical switch of the device 101, or else a button of a remote control connected to the device 101, or else pronounce a voice command which will be interpreted as a request to activate the device 101, or any other variant of a change in the electrical state of the device 101 representative of a wish to use said device 101. Another example can be the detection of an action of a system external to the invention, for example, in an industrial context, a system which controls the switching on of the devices following a schedule decided a priori. The detection phase b) can be carried out by any of the electrical devices 101, 102, 103 and 104 which are connected to one another by the communication link LAN.

Following the phase b) of detecting the change in the electrical state of the device 101, the method continues with the phase c) of managing the electrical power supply states of the other devices 102 and 103 in the group GRP. The management phase c) must ensure that the criterion according to which only one of the devices in the group GRP can be used at once at a given moment is respected. As it is possible that the other devices 102 and 103 in the group GRP are already in a state of very low power consumption, for example in a power supply cut-off or standby state, the management phase may not comprise a specific action if the criterion remains respected even after the change in the electrical state of the device 101. In this case, in the situation depicted in the left part of FIG. 1, the device 102 in the group GRP is in an ON electric power supply state. To ensure, following the phase of detecting the change in the electrical state of the device 101, that the criterion that only one of the devices 101, 102, 103 in the group GRP can be used at once at a given moment, it will therefore be necessary for the management phase c) to guarantee that the criterion is respected and for an order to change electrical state to be issued for the device 102.

The right part of FIG. 1 shows the situation in which electric power is supplied to the devices 101, 102, 103 and 104 after the phase c) of managing the electrical power supply states of the other devices 102 and 103 in the group GRP. As only one of the electrical devices 101, 102 and 103 in the group GRP can be used at once at a given moment, it was necessary to manage at least the electric power supply state of the device 102 and, for example, address at least one order to change electrical state to the device 102. The latter, which was in the ON electric power supply state in the left part of FIG. 1, is in the OFF state in the right part.

The criterion according to which only one of the electrical devices 101, 102 and 103 in the group GRP can be used at once at a given moment is indeed respected. As far the device 104 is concerned, as it is outside the group GRP, its ON electric power supply state does not change between the left part and the right part of FIG. 1. For the device 103 in the group GRP, its electric power supply state was OFF in the left part of FIG. 1 and remains OFF in the right part. There may have been no order to change electrical state issued for the device 103 in the case where the phase c) of managing the electric power supply states comprises sending orders to a subset of devices. Or else, if the management phase c) comprises systematically sending orders to change electrical state, the order sent for the device 103 has not changed its electric power supply state.

It can be noted that no mention is made in FIG. 1 of the one or more entities which perform the method. All the computing capabilities of the devices 101, 102, 103 and 104 can be used to carry out the grouping, detection and management phases a) to c). External devices can also be used, for example to make it possible for a user to carry out the grouping phase a). The devices 101, 102 and 103 in the group GRP must simply be able to execute orders to change electrical state. This can be guaranteed as a last option by plugging the devices 101, 102 and 103 in the group GRP into connected power outlets which can receive power supply cut-off messages.

Let it also be specified that the notion of devices can be extended in order to take into account combinations of devices. A device within the meaning of the invention can, in certain examples, be an abstract device composed of several small devices which contribute to fulfilling the functionality of the abstract device. For example, a personal computer can be seen, in certain configurations, as an abstract device composed of other devices such as a screen, a keyboard, and a workstation or computer tower or other components. The devices of which the abstract device is composed can have their own electric power supply or else can share only one electrical power source or else use any combination. The method can apply to abstract devices composed of several devices. In this case, the grouping phase a) can concern abstract devices composed of other, smaller devices. The management phase c) will ensure that the grouping criterion indeed remains respected, taking into account the use of possible abstract devices. If an order to change electrical state is sent to an abstract device during the management phase c), it will apply to the devices of which this abstract device is composed.

FIG. 2 presents an application of the management method similar to that described in FIG. 1 but for a different architecture.

FIG. 2 depicts four electrical devices 100, 101, 102 and 103. The electric power supply state of the devices 100, 101, 102 and 103 is depicted in the same way as in FIG. 1 with a rectangle containing the words ON and OFF. The electrical state of the device under consideration is depicted in FIG. 2 by the emboldening of the word ON or of the word OFF. When the word ON is in bold, the concerned device is supplied with electric power. When the word OFF is in bold, the concerned device is supplied with minimum power.

In FIG. 2, the device 100 is designated as the main device intended to be used exclusively by one of the secondary devices 101, 102 and 103. These three devices 101, 102 and 103 are grouped following the phase a) of grouping in the group GRP. Indeed, these secondary devices 101, 102 and 103 must have exclusive access to the main device 100 in order to fulfill their functionality. In other words, the secondary devices 101, 102 and 103 verify the criterion that only one of the secondary devices 101, 102 and 103 can use the main device 100 at once at a given moment. It is therefore correct to group them in the group GRP because only one of the devices 101, 102 and 103 can be used at once at a given moment.

The main device 100 will typically be a television or else a high-fidelity channel and the secondary devices 101, 102 and 103 will typically be devices which use the device 100 as an audio-visual signal output, for example video game consoles or else DVD or Blu-ray players, or else TV decoders, or else computers, or any other device.

In FIG. 2, the electrical devices 100, 101, 102 and 103 are connected by a communication link which is made through the main device 100. The secondary devices 101, 102 and 103 have a link with the device 100 which can be made, for example, by radio-frequency technology such as Bluetooth, the RF4CE protocol (acronym for Radio Frequency For Consumer Electronics) or UWB (acronym for Ultra Wide Band), or else by a wired link, or else by a link using power line communications. These links are depicted in FIG. 2 by arrows between the main device 100 and the secondary devices 101, 102 and 103. These are, for example, the communication links which make it possible for the secondary devices 101, 102 and 103 to address an audio-visual signal to the main device 100.

The left part of FIG. 2 shows the situation as far as the electrical state of the devices 100, 101, 102 and 103 is concerned, and the right part shows the situation of the electrical state of the same devices 100, 101, 102 and 103 after the phase b) of detecting a change in the electrical state of the device 101, depicted by the arrow labelled “101 ON”, and after the phase c) of managing the electrical power states. As for FIG. 1, the consequence of detecting the change in the electrical state of the device 101 is the change in the state of the device 102, the state of which moves from ON to OFF. Indeed, only one device from the group GRP of secondary devices 101, 102 and 103 can be used at once at a given moment, therefore the desire to use the device 101 implies a move to the device 102 not being supplied with electric power. The electrical state of the secondary device 102 in the right part of FIG. 2 is therefore OFF. As for the situation described in FIG. 1, the secondary device 103 did not have to change its electrical state OFF. As above, in a variant of the method, no order was issued to the secondary device 103 because this was not necessary for executing the method. Or else, in another variant of the method, an order was indeed issued to the secondary device 103 but had no effect because the secondary device 103 was already in the targeted electric power supply state.

The architecture described in FIG. 2 suggests a possible implementation of the management method in which it is the main device 100 which carries out the phases a) to c) of grouping devices, of detecting a change in state and of managing electric power supply states. In a variant, the phases a) to c) of grouping devices, of detecting a change in state and of managing electric power supply states are carried out by all or some of the devices 100, 101, 102 or 103.

Finally, let it be known that the various computations in question in this text are performed by modules which are software components or hardware components or combinations of hardware and software components, a software component itself corresponding to one or more computer programs or subroutines or, more generally, to any element of a program capable of implementing a function or a set of functions. In the same way, a hardware component corresponds to any element of a hardware assembly capable of implementing a function or a set of functions for the module concerned (integrated circuit, chip card, memory card etc.). These software components can use any type of computer technology in terms of compiled or interpreted programming languages or a combination of the two, as well as in terms of operating systems.

1. A management method for managing an electric power supply to electrical devices which are connected to one another via a communication link and capable of taking several electric power supply states, wherein the method is implemented by a management entity device and comprises:
a) a phase of grouping a plurality of the electrical devices into a group according to a criterion that only one of these plurality of electrical devices can be used at once at a given moment;
b) a phase of detecting a change in the electrical state of a first electrical device of the plurality of electrical devices in the group to a new state which is obtained following the grouping, the new state being representative of a desire to use said first electrical device; and
c) a phase of managing the electric power supply states of the other electrical devices in said group according to the criterion that only one of the electrical devices in the group can be used at once at a given moment.

2. The management method as claimed in claim 1, wherein one of the electrical devices is designated as a main device to be used by secondary devices of the electrical devices, and wherein the grouping phase a) applies to the secondary devices according to the criterion that only one of these secondary devices uses the main device at once at a given moment.

3. The management method as claimed in claim 2, wherein phases a) to c) are carried out by the main device, which implements the management entity device.

4. The management method as claimed in claim 1, wherein phases a) to c) are carried out by all or some of the electrical devices, which implement the management entity device.

5. The management method as claimed in claim 1, wherein the managing phase c) comprises systematically sending orders to change electrical state to all the other electrical devices in the group.

6. The management method as claimed in claim 1, wherein the managing phase c) comprises sending orders to change electrical state to a subset of said other electrical devices in the group so as to respect the criterion that only one of the devices in the group can be used at once at a given moment, the electrical devices in said subset being chosen according to their respective electrical states.

7. The management method as claimed in claim 5, wherein at least one of the orders to change electrical state is a standby order.

8. The management method as claimed in claim 5, wherein at least of the orders to change electrical state is an order to cut off the electric power supply.

9. A management entity capable of performing a method for managing an electric power supply to electrical devices which are connected to one another via a communication link and capable of taking several electric power supply states, wherein said entity comprises:
at least one processor; and
at least one non-transitory computer readable medium comprising instructions stored thereon which when executed by the at least one processor configure the management entity to perform the method for managing, which comprises:
a) grouping a plurality of the electrical devices into a group according to a criterion that only one of these plurality of electrical devices can be used at once at a given moment;
b) detecting a change in the electrical state of a first of the plurality of electrical devices in the group to a new state which is obtained following the grouping, the new state being representative of a desire to use said first electrical device; and
c) managing the electric power supply states of the other electrical devices in said group according to the criterion that only one of the electrical devices in the group can be used at once at a given moment.

10. The management entity of claim 9, wherein the management entity is implemented by at least one of the electrical devices.

11. (canceled)

12. Anon-transitory computer readable data medium on which a computer program is stored, comprising sequences of instructions for implementing a management method for managing an electric power supply to electrical devices when the instructions are executed by a processor of a management entity, wherein the electrical devices are connected to one another via a communication link and are capable of taking several electric power supply states, and wherein the method comprises:
a) a phase of grouping a plurality of the electrical devices into a group according to a criterion that only one of these plurality of electrical devices can be used at once at a given moment;
b) a phase of detecting a change in the electrical state of a first electrical device of the plurality of electrical devices in the group to a new state which is obtained following the grouping, the new state being representative of a desire to use said first electrical device; and
c) a phase of managing the electric power supply states of the other electrical devices in said group according to the criterion that only one of the electrical devices in the group can be used at once at a given moment.
